(19) United States
(12) Patent Application Publication
(10) Pub. No.: US 2007/0007491 A1
(43) Pub. Date: Jan. 11, 2007

(54) Optical element, in particular for an objective or an illumination system of a microlithographic projection exposure apparatus

(76) Inventors: Ralf Mueller, Aalen (DE); Olaf Dittmann, Bopfingen (DE); Michael Totzeck, Schwaebisch Gmuend (DE); Daniel Kraehmer, Aalen (DE); Christoph Zaczek, Heubach (DE); Karl-Heinz Schuster, Koenigsbronn (DE)

Correspondence Address: FISH & RICHARDSON PC, P.O. BOX 1022, MINNEAPOLIS, MN, 55440-1022, US

(21) Appl. No.: 11/414,692

(22) Filed: Apr. 28, 2006

(30) Foreign Application Priority Data
May 4, 2005 (DE) 10 2005 021 340.5

(51) Int. Cl. C09K 19/52

(52) U.S. Cl. 252/299.01

(57) ABSTRACT

The invention concerns an optical element, in particular for an objective or an illumination system of a microlithographic projection exposure apparatus, including a substrate which for light of a predetermined working wavelength which passes through the substrate causes a first retardation between mutually perpendicular polarization states, and a layer which is epitaxially grown on the substrate and which is made from a material with non-cubic crystal structure, which by virtue of natural birefringence causes a second retardation between mutually perpendicular polarization states, which at least partially compensates for the first retardation caused in the substrate.

### CROSS-REFERENCE TO RELATED APPLICATION

Under 35 U.S.C. §119, this application claims priority to German Patent Application No. 10 2005 021 340.5, filed May 4, 2005, the contents of which are hereby incorporated by reference.

### BACKGROUND OF THE INVENTION

1. Field of the Invention

The invention concerns an optical element, in particular for an objective or an illumination system of a microlithographic projection exposure apparatus.

2. Description of the Related Art

It is known that, in the case of single-crystalline cubic materials such as for example calcium fluoride which is used in microlithography in particular at working wavelengths of less than 250 nm, in spite of the high level of symmetry present in the crystal structure, the effect of what is referred to as intrinsic birefringence occurs, which at the high levels of resolution required in microlithography, results in telecentry errors and losses in contrast and thus causes increased difficulty in optical imaging.

Intrinsic birefringence in calcium fluoride single crystals was established in particular in the Internet publication “Preliminary Determination of an Intrinsic Birefringence in CaF₂” by John H. Burnett et al., NIST Gaithersburg Md. 20899 USA (published on 07.05.01). The measurements presented therein show that intrinsic birefringence is heavily direction-dependent and increases markedly with decreasing wavelength.

Various approaches are known for reducing the effect of intrinsic birefringence.

### SUMMARY OF THE INVENTION

The object of the present invention is to provide an optical element, in particular for an objective or an illumination system of a microlithographic projection exposure apparatus, as well as an optical system, which permit an improvement in imaging quality in spite of the presence of optical elements with intrinsic or also natural birefringence.

That object is attained in accordance with the features of the independent claims.

An optical element according to the invention, in particular for an objective or an illumination system of a microlithographic projection exposure apparatus, comprises:

a substrate which for light of a predetermined working wavelength which passes through the substrate causes a first retardation between mutually perpendicular polarization states; and

a layer which is epitaxially grown on the substrate and which is made from a material with non-cubic crystal structure, which by virtue of natural birefringence causes a second retardation between mutually perpendicular polarization states, which at least partially compensates for the first retardation caused in the substrate.

In accordance with the invention in that case the naturally birefringent layer which is non-cubic in its crystal structure provides that the retardation in the substrate is reduced and preferably substantially compensated. In accordance with the invention that is achieved in that on the one hand the materials of the substrate and the layer are so selected that the signs of the retardations caused by the respective birefringence are in opposite relationship in the substrate and the layer respectively so that a compensation effect can occur. Furthermore in accordance with the invention the thickness of the layer is so matched to the dimensions of the substrate that the effect of natural birefringence in the layer, in terms of retardation, does not exceed that of birefringence in the substrate but partially or almost completely compensates for same.

In that respect the layer is epitaxially grown on the substrate. Therefore, in accordance with the invention, unlike the use of a multiple layer system (making use of the effects produced therein of interference birefringence, that is to say the birefringence caused within an interference layer system by interface transmission phenomena which are different for mutually orthogonal polarization states, and possibly also form birefringence) crystalline birefringence inherent in the material of a layer (in particular a single layer) is utilized in order to achieve the desired compensation effect in respect of the retardation caused by the substrate.

Making use of the birefringence inherent in the material of an epitaxially grown single layer, in accordance with the invention, is advantageous insofar as it has been found that from time to time, when using a multiple layer system, the magnitude of the retardation caused by interference birefringence and/or form birefringence, depending on the respective magnitude of birefringence distribution of the substrate, means that the compensation effect achieved is not adequate or is accompanied by an excessively severe impairment in respect of the transmission properties and/or mechanical stability. Furthermore, as a consequence of the epitaxial growth of a layer in accordance with the invention, problems are avoided which arise when using a crystalline plate and result either in an excessively great birefringence effect for the plate (with excessively large plate thickness) or excessively low mechanical stability (in the case of an excessively thin plate thickness).

In that respect in the present context the term epitaxially grown layer is used to denote a layer which exhibits at least substantially an orderly crystal growth on the substrate. In other words, a substantially single-crystalline structure is produced in the direction of growth (in perpendicular relationship to the substrate surface) and the structure in the lateral direction is preferably also substantially single-crystalline (that is to say typically over regions of a size in the region of approximately one or more cm²).

In accordance with a first aspect of the invention the substrate is produced from a material with a cubic crystal structure, wherein the first retardation is caused in the substrate by intrinsic birefringence.

In that case, the naturally birefringent layer which is non-cubic in its crystal structure reduces the consequence of the effect of intrinsic birefringence in the cubic substrate and preferably substantially compensates for same, in which respect once again the signs of the retardations in the substrate and the layer respectively, which are caused by the respective birefringence (“intrinsic” in the substrate and “natural” in the layer) are in opposite relationship so that a compensation effect can occur and wherein the thickness of the layer is so matched to the dimensions of the substrate that the effect (typically higher by orders of magnitude) of the natural birefringence in the layer, in respect of retardation of light passing through the optical element, partially or almost completely compensates for that of intrinsic birefringence in the substrate.

In accordance with a preferred embodiment the material of the layer is an optically uniaxial crystal material. In that respect preferably an optical crystal axis of the optically uniaxial crystal material is substantially parallel to an axis of the optical element.

In accordance with the invention the feature that the optical crystal axis of the material of the layer is “substantially” parallel to an axis of the optical element denotes that an angle between said optical crystal axis and the axis of the element is less than 5°, preferably less than 3°, still more preferably less than 1°.

In accordance with an embodiment the maximum value of the total retardation between mutually perpendicular polarization states in comparison with an identical substrate without the layer, at the predetermined working wavelength, is reduced by at least 25%, preferably at least 50% and still more preferably by at least 75%.

In accordance with an embodiment provided on the substrate is only said one epitaxially grown layer, that is to say there is only a single layer (and not a multiple layer system) on the substrate.

In accordance with an embodiment the substrate is produced with such a crystal cut that the axis of the element is parallel to the <111>-crystal direction and can be produced in particular from calcium fluoride in (111)-orientation.

In matching relationship therewith the material of the layer is then preferably of a hexagonal or trigonal crystal structure and can be in particular lanthanum fluoride, wherein the optical crystal axis is substantially parallel to the <111>-crystal direction in the material of the substrate. In this case for example crystalline growth of the layer can occur if the relevant lattice parameter of the hexagonal structure is in particular about a*√2*½ (wherein a is the relevant lattice parameter of the substrate).

In accordance with a further embodiment the substrate is produced with such a crystal cut that the axis of the element is substantially parallel to the <100>-crystal direction. In matching relationship therewith the material of the layer is then preferably of a tetragonal crystal structure. In that case crystalline growth of the layer can occur perpendicularly to the (100)-plane of the substrate if the two equal-length axes of the tetragonal structure are oriented along the cubic (100)- or (010)-direction respectively.

In accordance with a further preferred embodiment the substrate is produced with such a crystal cut that the axis of the element is substantially parallel to the <110>-crystal direction. In matching relationship therewith the material of the layer then preferably involves a monoclinic structure.

In accordance with another aspect of the invention the substrate can also be made from a material with a non-cubic crystal structure, wherein the first retardation in the substrate is produced on the basis of natural birefringence. In that case the non-cubic, naturally birefringent layer means that the consequence of the effect of natural birefringence in the substrate which is also non-cubic is reduced and preferably substantially compensated. In accordance with the invention that is achieved in that on the one hand the materials of the substrate and the layer are so selected that the signs of the retardations caused by the respective natural birefringence in the substrate and in the layer are in opposite relationship so that a compensation effect can occur in any case. Furthermore the materials of the substrate and the layer which is epitaxially grown thereon in at least region-wise manner are so matched that the material of the layer has a natural birefringence which is substantially higher—typically by one or more orders of magnitude—in comparison with the material of the substrate so that the retardation in the substrate can be adequately compensated by the effect of the layer. Overall the materials and thicknesses are so matched that the retardation in the layer does not exceed the retardation in the substrate but partially or almost completely compensates for same. In that respect the thicknesses scale inversely with the ratio of the birefringences. If therefore the birefringence is 100 times greater, a layer of one hundredth of the thickness of the substrate is sufficient (that thickness is possibly also to be scaled when different refractive indices are involved with the geometrical path length of the beams).

In accordance with a further aspect the invention concerns an optical system comprising a plurality of lenses, wherein provided on at least one lens is at least one layer of a material with non-cubic crystal structure, which by virtue of natural birefringence for light of a predetermined working wavelength passing through the layer causes a retardation between mutually perpendicular polarization states, wherein an optical crystal axis of said material is substantially parallel to an optical axis of the optical system and wherein for light passing through the optical system the maximum value of the retardation between mutually perpendicular polarization states is reduced in comparison with a corresponding optical system without the layer.

In accordance with a further aspect the invention concerns an optical element, in particular for an objective or an illumination system of a microlithographic projection exposure apparatus, comprising a substrate which is produced from calcium fluoride crystal in (111)-orientation and is of a first thickness d₁, and a layer which is epitaxially grown on the substrate and which is made from lanthanum fluoride and is of a second thickness d₂, wherein the ratio d₁/d₂ of the first thickness to the second thickness is at least 7*10³. The ratio d₁/d₂ of the first thickness to the second thickness may in particular be at least 8*10³ and preferably in the range of 8*10³ to 9*10³.

In accordance with a further aspect the invention concerns an optical element, in particular for an objective or an illumination system of a microlithographic projection exposure apparatus, comprising a substrate which for light of a predetermined working wavelength which passes through the substrate causes a retardation between mutually perpendicular polarization states; and at least one layer which is grown on the substrate in oriented relationship and which is made from a polymer which is transparent at the working wavelength. In an embodiment, the layer of the transparent polymer causes a retardation between mutually perpendicular polarization states, which is of opposite sign to the retardation caused in the substrate. In particular, the retardation caused in the substrate may be substantially compensated by the retardation caused in the layer of the transparent polymer.

In accordance with a further aspect the invention concerns an optical element, in particular for an objective or an illumination system of a microlithographic projection exposure apparatus, comprising a substrate which is made from a first material with a cubic crystal structure with a first lattice parameter, and at least one layer which is epitaxially grown on the substrate and which is made from a second material with a cubic crystal structure with a second lattice parameter, wherein the second lattice parameter is different from the first lattice parameter. In an embodiment, light passing through the substrate the substrate causes a first retardation between mutually perpendicular polarization states, and the epitaxially grown layer causes a second retardation between mutually perpendicular polarization states, which is of opposite sign to the first retardation. In particular, the first retardation caused in the substrate is substantially compensated by the second retardation caused in the epitaxially grown layer.

The working wavelength according to the present invention may be less than 250 nm, in particular less than 200 nm, and in particular less than 160 nm.

The invention further concerns an illumination system, a projection objective as well as a microlithographic projection exposure apparatus with an optical element according to the invention and/or an optical system according to the invention.

Further configurations of the invention are to be found in the description and the appendant claims.

### BRIEF DESCRIPTION OF THE DRAWINGS

The invention is described in greater detail hereinafter by means of embodiments by way of example illustrated in the accompanying drawings in which:

FIG. 1 is a diagrammatic view, not true to scale, of the structure of an optical element in accordance with a preferred embodiment of the present invention,

FIGS. 2a-c show an illustration of the effect of intrinsic birefringence in a plane-parallel (100)-lens (FIG. 2a), (111)-lens (FIG. 2b) and (110)-lens (FIG. 2c) in three-dimensional diagrammatic views,

FIG. 3 is a diagrammatic view, not true to scale, of the structure of an optical element in accordance with a further preferred embodiment of the invention,

FIG. 4 is a diagrammatic view, not true to scale, of the structure of an optical system in accordance with a preferred embodiment of the invention,

FIG. 5 is a view to explain the principle of the configuration of an optical element according to a further preferred embodiment of the invention,

FIG. 6 shows the lens section of a refractive projection objective, and

FIG. 7 is a diagrammatic view of a microlithographic projection exposure apparatus.

### DETAILED DESCRIPTION OF PREFERRED EMBODIMENTS

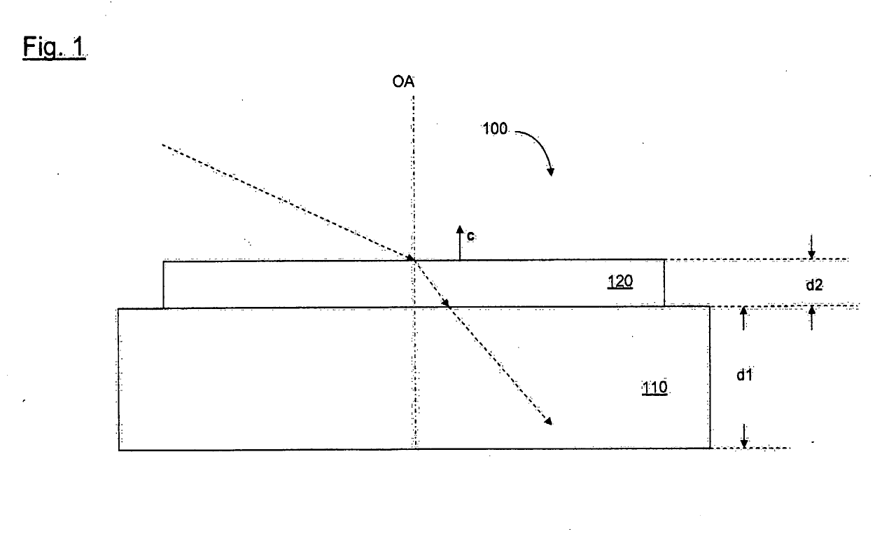

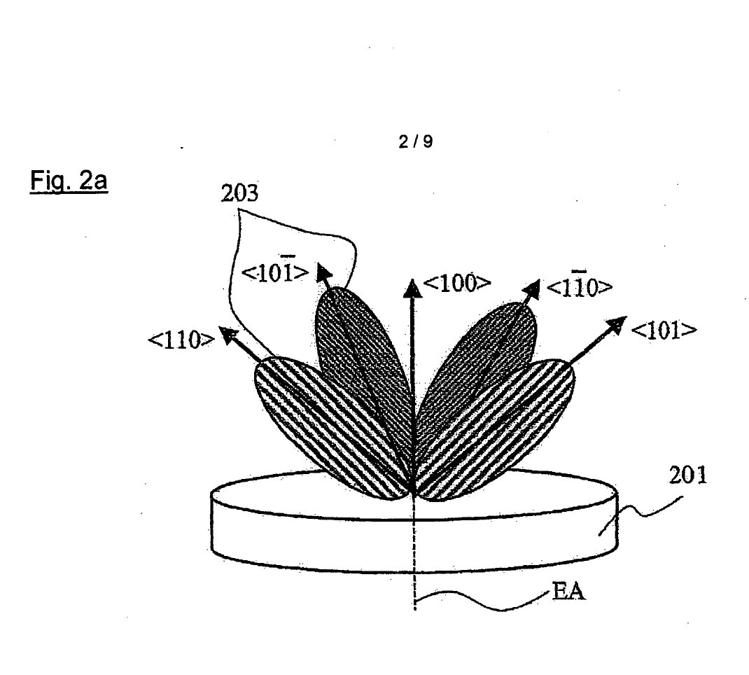

FIG. 1 is a diagrammatic view, not true to scale, showing the structure of an optical element 100 according to a first preferred embodiment of the invention.

The optical element 100 includes a substrate 110 in the form of a plane-parallel plate of calcium fluoride, which is of a thickness d₁ and which is produced in a (111)-orientation, that is to say the axis EA of the element is perpendicular to the {111}-crystal plane and thus parallel to the <111>-crystal direction of the substrate 110. The diameter of the plane-parallel plate is of any desired value and can be for example 20 cm. The thickness d₁ is also basically of any desired value and in the illustrated embodiment can be assumed to be d₁=2 cm.

A layer 120 of lanthanum fluoride is applied to the substrate 110. The layer 120 is grown in a defined manner and in crystalline form so that the optical crystal axis in the hexagonal crystal structure of the lanthanum fluoride material, referred usually and also hereinafter as the “c-axis”, is parallel to the axis EA of the element and thus perpendicular to the {111}-crystal plane of the calcium fluoride material of the substrate 110.

The provision of the layer 120 on the substrate 110 is preferably effected by epitaxial growth by means of a low-energy PVD process (PVD=“Physical Vapor Deposition”), both thermal vapor deposition (by means of electron beam vapor deposition or resistance heating) or also molecular beam epitaxy (MBE) being suitable for that purpose. For example, for epitaxial growth by means of thermal vapor deposition—with the substrate having been previously cleaned—suitable coating temperatures between ambient temperature and 350° C., preferably in the range of 150° C. to 300° C., most preferably in the range of 200° C. to 250° C., can be selected. The coating rates of LaF₃ should be in the range of 0.01 to 2 nm/s, preferably from 0.1 to 0.5 nm/s. The basic pressure should be in the range below 10⁻⁵ mbar, preferably from 10⁻⁶ to 10⁻⁷ mbar.

When the layer 120 is grown on the substrate 110, it is no obstacle in regard to attaining the advantages according to the invention if individual smaller single-crystalline regions or islands of mutually different orientation are present in the layer 120, if therefore the layer 120 is not single-crystalline over the entire surface of the substrate 110 as long as the drawing direction is perpendicular to the surface of the substrate.

The calcium fluoride material of the substrate 110 exhibits the effect of intrinsic birefringence in dependence on the angle of incidence α relative to the axis EA of the element, as will firstly be described generally hereinafter. The layer 120 is of a thickness d₂ which is so matched to the thickness d₁ of the substrate 110 that that effect of intrinsic birefringence in the optical element 100 is reduced.

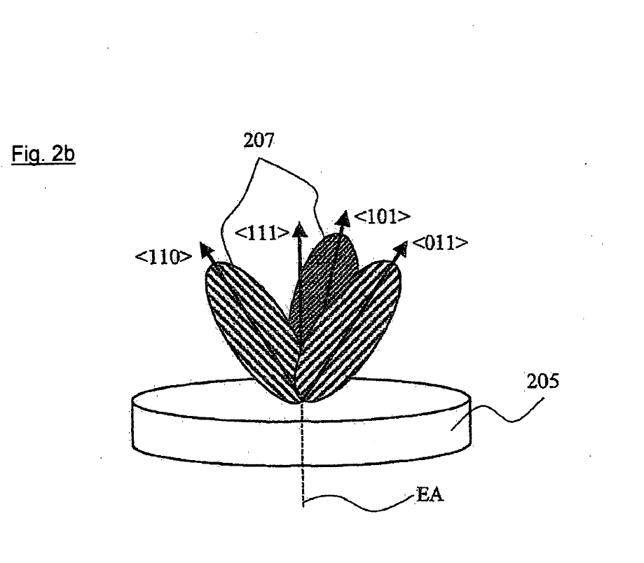

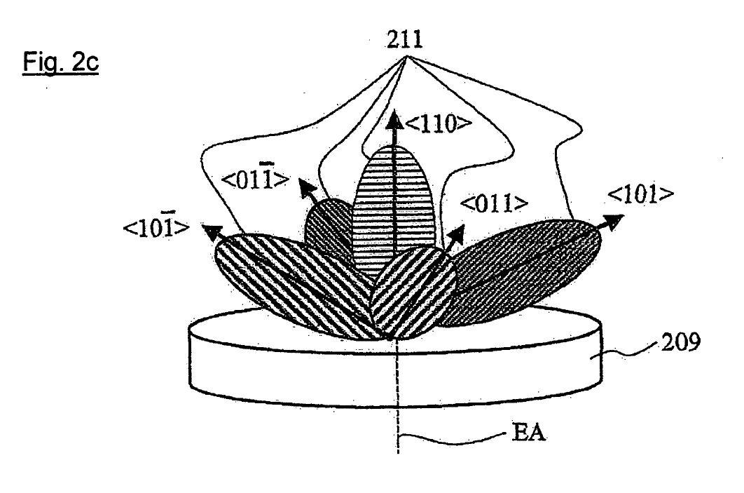

FIG. 2a firstly shows in a three-dimensional view how intrinsic birefringence in the calcium fluoride material is related to the crystal directions if the lens axis EA faces in the <100>-crystal direction. The Figure shows a round plane-parallel plate 201 of calcium fluoride. In this case the lens axis EA points in the <100>-crystal direction. Besides the <100>-crystal direction the <101>-, <1 1̅0>-, <10 1̅>- and <110>-crystal directions are also shown as arrows. Intrinsic birefringence is diagrammatically illustrated by four “lobes” 203, the surface areas of which specify the magnitude of intrinsic birefringence for the respective beam direction of a light beam. Maximum intrinsic birefringence occurs in the <101>-, <1 1̅0>-, <10 1̅>- and <110>-crystal directions, that is to say for light beams with a spread angle of 45° and an azimuth angle of 0°, 90°, 180° and 270° within the lens. For azimuth angles of 45°, 135°, 225° and 315° there are minimum values in respect of intrinsic birefringence. Intrinsic birefringence disappears for a spread angle of 0°.

FIG. 2b shows in a three-dimensional view how intrinsic birefringence is related to the crystal directions if the lens axis EA faces in the <111>-crystal direction. The Figure shows a round plane-parallel plate 205 of calcium fluoride. In this case the lens axis EA faces in the <111>-crystal direction. Besides the <111>-crystal direction the <011>-, <101>- and <110>-crystal directions are also shown in the form of arrows. Intrinsic birefringence is diagrammatically illustrated by three “lobes” 207 whose surface areas specify the magnitude of intrinsic birefringence for the respective beam direction of a light beam. Maximum intrinsic birefringence occurs in each case in the <011>-, <101>- and <110>-crystal directions, that is to say for light beams with a spread angle of 35° and an azimuth angle of 0°, 120° and 240° within the lens. For azimuth angles of 60°, 180° and 300° there are respective minimum values in respect of intrinsic birefringence. Intrinsic birefringence disappears for a spread angle of 0°.

FIG. 2c shows in a three-dimensional view how intrinsic birefringence is related to the crystal directions if the lens axis EA faces in the <110>-crystal direction. The Figure shows a round plane-parallel plate 209 of calcium fluoride. In this case the lens axis EA points in the <110>-crystal direction. Besides the <110>-crystal direction the <01 1̅>-, <10 1̅>-, the <101>- and the <011>-crystal directions are also shown as arrows. Intrinsic birefringence is diagrammatically illustrated by five “lobes” 211 whose surface areas specify the magnitude of intrinsic birefringence for the respective beam direction of a light beam. Maximum intrinsic birefringence occurs on the one hand in the direction of the lens axis EA, and on the other hand respectively in the <01 1̅>-, <10 1̅>-, <101>- and <011>-crystal directions, that is to say for light beams with a spread angle of 0° or with a spread angle of 60° respectively and the four azimuth angles which are produced by projection of the <01 1̅>-, <10 1̅>-, <101>- and <011>-crystal directions in the {110}-crystal plane. Such high spread angles however do not occur in crystal material as the maximum spread angles are limited to less than 45° by the refractive index of the crystal.

With reference once again to FIG. 1 intrinsic birefringence accordingly disappears for a beam which impinges in parallel relationship with the axis EA of the element and which is thus propagated in the <111>-crystal direction, and is at a maxim for beam propagation in the <110>-crystal direction which is at an angle α₁=35° with respect to the <111>-crystal direction and thus the axis EA of the element. The retardation resulting from that intrinsic birefringence which is at a maximum upon beam propagation in the <110>-crystal direction is about r₁=−3.4 nm/cm in the calcium fluoride material with a working wavelength of 193 nm which is the basis for the present embodiment by way of example. The term “retardation” is used to identify the difference in the optical paths of two orthogonal (mutually perpendicular) polarization states.

The lanthanum fluoride material of the layer 120 is “naturally birefringent” caused by the low level of symmetry of its hexagonal crystal structure and the optical anisotropy following therefrom, wherein the difference between the refractive indices nₒ for the ordinary ray and nₑ for the extraordinary ray is about nₒ−nₑ=0.0094.

In the lanthanum fluoride material of the layer 120, in dependence on the angle α₂ of beam propagation α relative to the optical crystal axis and thus in the present case relative to the axis EA of the element, caused by the effect of natural birefringence, there is a retardation r₂(α₂) which is approximately given by r₂≈(nₒ−nₑ)*d*sin²(α₂) and which thus in the case of beam propagation in parallel relationship with the optical crystal axis disappears while in the case of beam propagation in perpendicular relationship with the optical crystal axis it assumes a maximum.

If consideration is given to a beam which is propagated in the calcium fluoride material of the substrate 110 at an angle α₁=35° relative to the <111>-crystal direction and thus relative to the axis EA of the element, that is to say in the <110>-crystal direction, maximum intrinsic birefringence occurs for that beam in accordance with the foregoing description. The same beam is propagated in the lanthanum fluoride material of the layer 120, having regard to the approximate refractive indices of both materials which apply at 193 nm of n₁ (calcium fluoride)≈1.51 and n_{2.0} (lanthanum fluoride)≈1.71 in accordance with the law of refraction which applies in respect of the ordinary ray n₁*sin α₁=n₂*sin α₂ at an angle of about α₂=≈30.4° with respect to the optical crystal axis and thus with respect to the axis EA of the element. Accordingly, due to the effect of natural birefringence in the lanthanum fluoride material of the layer 120, there is a retardation r₂ in dependence on the thickness d₂ of the layer 120 of about r₂≈(nₒ−nₑ)*d₂*sin²(α₂)≈0.0094*d₂*0.256. For the ratio of retardation r₂ and thickness d₂ of the layer 120 that results in the expression r₂/d₂≈2.4*10⁻³≈2.4 nm/μm. The absolute values of the specified refractive indices may possibly vary, which however basically does not in any way change the illustrated principle of the present invention.

As that retardation r₂, caused by natural birefringence, in the lanthanum fluoride material of the layer 120, of opposite sign is like the retardation r₁ caused by intrinsic birefringence in the calcium fluoride material of the substrate 110, upon suitable matching of the thicknesses d₂ and d₁ in the optical element 100 in accordance with the invention it is possible to achieve substantial mutual compensation and thus a substantial reduction in the consequence of the effect of intrinsic birefringence in the calcium fluoride material of the substrate 110 to a total retardation in the optical element 100:

If for example the thickness d₁ of the substrate 110 is d₁=2 cm, then the geometrical path length of the above-indicated beam which is propagated in the substrate 110 at the angle α₁=35° is d₁′=d₁*cos α₁≈1.64 cm, so that, for that beam, there is a retardation in the substrate 110 of about r_{1,max}≈(−3.4 nm/cm)*1.64 cm≈−5.58 nm. To provide for compensation of that retardation by a retardation in the layer 120 which is of equal magnitude in value but which is of opposite sign therefore the optimum thickness of the layer 120 is approximately d₂=r_{1,max}/2.4 nm/μm≈5.58/2.4 nm/μm≈2.325 μm. In that case accordingly the thickness ratio d₁/d₂=2 cm/2.325 μm≈8600.

In accordance with the substantial compensation achieved in the foregoing example in respect of the retardation caused by intrinsic birefringence in the calcium fluoride material of the substrate 110 the distribution of the retardations is also of reduced values in dependence on the angle of incidence on the optical element 100 in comparison with an optical element without the layer 120.

Furthermore the above example provides that partial compensation of the retardation caused by intrinsic birefringence in the substrate is also always effected by the layer 120 insofar as the thickness d₂ thereof is less than d_{2,max}≈4.65 μm. In that case therefore the thickness ratio d₁/d₂=2 cm/4.65 μm≈4300. For larger thicknesses of the layer (or lower thickness ratios d₁/d₂) there is an increase in the total retardation and thus a worsening as the retardation caused by the layer 120 leads to a total retardation which exceeds the effect of intrinsic birefringence in the substrate 110 (without layer 120).

In accordance with a preferred embodiment the thickness d₂ is matched to the thickness d₁ of the substrate 110 in such a way that, for a beam with a maximum retardation of r_{1,max} in the substrate 110 (in accordance with the specific embodiment with (111)-calcium fluoride and therefore a beam with beam propagation at an angle of 35° relative to the axis of the element in the substrate 110) there is in the layer a retardation of opposite sign, the quantitative value of which is at least 50%, further preferably at least 75% and most preferably precisely 100% of the maximum retardation r_{1,max} in the substrate 110.

The invention is not limited either to the materials or the dimensions and geometries in the above-discussed embodiment which serves only to explain the principle of the invention. Rather, the only important consideration in the above-indicated embodiment is that the material of the layer 120 is suitably selected in relation to the material of the substrate 110 in such a way that on the one hand the signs of the retardations in the substrate and layer respectively which are caused by the respective birefringence (“intrinsic” in the substrate 110 and “natural” in the layer) are opposite so that the above-discussed partial or complete compensation effect is afforded. On the other hand the materials are to be so selected in relation to their lattice parameters that the above-indicated crystalline growth of the layer 120 is made possible with a defined drawing direction, in particular epitaxial growth.

So that the contribution to natural birefringence by the layer 120 is sufficiently great to already compensate at least in part for the intrinsic birefringence of the substrate 110 with a layer thickness which is as small as possible, the material of the layer preferably involves a great difference between the ordinary refractive index nₒ and the extraordinary refractive index nₑ.

Table 1 sets out an overview of materials by way of example which are suitable in accordance with the invention, with a relatively great difference between the ordinary refractive index nₒ and the extraordinary refractive index nₑ for the production of the layer, nₒ being larger than nₑ for those materials. An epitaxial layer consisting of one of those materials is thus basically suitable for compensating for the retardation in a substrate with a negative sign in respect of intrinsic birefringence, for example calcium fluoride (CaF₂), strontium fluoride (SrF₂), barium fluoride (BaF₂), lithium fluoride (LiF), sodium fluoride (NaF), potassium fluoride (KF), rubidium fluoride (RbF) or cesium fluoride (CsF).

The table also specifies in each case the ordinary refractive index nₒ and the extraordinary refractive index nₑ for λ=589 nm (and in the identification * for λ=365.5 nm, the identification ** for λ=248.338 nm and the identification *** for λ=193.304 nm). It is to be noted in that respect that, at lower wavelengths and in particular towards the working wavelengths which are typical for microlithography uses, of less than 250 nm (preferably about 248 nm, 193 nm or 157 nm), the refractive indices respectively rise, in which respect nₒ respectively rises more greatly than nₑ and thus also the refractive index difference nₒ−nₑ assumes still greater values than at λ=589 nm.

TABLE 1

| Material | nₒ | nₑ |
|---|---|---|
| Magnesite (MgCO₃) | 1.7031 | 1.5133 |
| | (1.7355)* | (1.5272)* |
| Dolomite (CaMg[CO₃]₂) | 1.6799 | 1.5013 |
| Rhodochrosite (MnCO₃) | 1.818 | 1.595 |
| Gehlenite (2CaO.Al₂O₃SiO₂) | 1.687 | 1.658 |
| Calcite (CaCO₃) | 1.6585 | 1.4864 |
| | (1.6923)* | (1.5016)* |
| | (1.7721)** | (1.5342)** |
| Smithsonite (ZnCO₃) | 1.8485 | 1.6212 |
| Eitelite (MgNa₂[CO₃]₂ or Na₂CO₃.MgCO₃) | 1.605 | 1.450 |
| Potassium magnesium carbonate | 1.597 | 1.470 |
| (MgK₂[CO₃]₂ or K₂CO₃.MgCO₃) | | |
| Buttschlitt (Ca₂K₆[CO₃]₅.6H₂O) | 1.595 | 1.455 |
| SrCl₂.6H₂O | 1.53560 | 1.48565 |
| Norsethite (BaMg[CO₃]₂ or BaCO₃.MgCO₃) | 1.694 | 1.519 |
| Cordylite (Ce₂Ba[(CO₃)₃F₂] or | 1.764 | 1.577 |
| La₂Ba[(CO₃)₃F₂] | | |
| Manganese dolomite (MnCa[CO₃]₂ or | 1.741 | 1.536 |
| MnCO₃.CaCO₃) | | |
| Manganese spar (MnCO₃) | 1.818 | 1.595 |
| Siderite (FeCO₃) | 1.875 | 1.633 |
| Sodium nitrate (NaNO₃) | 1.5874 | 1.3361 |
| Lithium nitrate (LiNO₃) | 1.735 | 1.435 |
| Barium borate (BaB₂O₄) | 1.6706 | 1.5542 |
| | (1.7022)* | (1.5751)* |
| | (1.7776)** | (1.6281)** |
| | (1.9197)*** | (1.7207)*** |
| Potassium cyanate (KCNO) | 1.575 | 1.412 |
| Ba(NO₂)₂.H₂O | 1.665 | 1.629 |
| Chloromagnesite (MgCl₂) | 1.675 | 1.590 |
| RbClO₃ | 1.572 | 1.484 |
| LiO₃ | 1.846 | 1.711 |
| Al₂O₃.MgO | 1.665 | 1.629 |
| [PdCl₄](NH₄)₂ | 1.712 | 1.549 |

Table 2 sets out an overview of materials by way of example which are suitable in accordance with the invention, with a relatively great difference between the ordinary refractive index nₒ and the extraordinary refractive index nₑ for the production of the layer, nₒ being smaller than nₑ for those materials. An epitaxial layer consisting of one of those materials is thus basically suitable for compensating for the retardation in a substrate with a positive sign in respect of intrinsic birefringence, for example yttrium aluminum garnet (Y₃Al₅O₁₂), magnesian spinel (MgAl₂O₄), calcium spinel (CaAl₂O₄), manganese spinel (MnAl₂O₄), lithium spinel (Al₅O₈Li) and pyrope (Mg₃Al₂Si₃O₁₂).

The Table also specifies in each case the ordinary refractive index nₒ and the extraordinary refractive index nₑ for λ=589 nm.

TABLE 2

| Material | nₒ | nₑ |
|---|---|---|
| NaCNO | 1.389 | 1.627 |
| Henotim (Y[PO₄]) | 1.7207 | 1.8155 |
| Bastnaesite ((Ce,La,Nd)[CO₃F]) | 1.7225 | 1.8242 |
| Synchysite (CeCa[(CO₃)₂F] | 1.6730 | 1.7690 |
| Parisite ((Ce,La)₂Ca[(CO₃)₃F₂]³) | 1.6717 | 1.7712 |
| Röntgenite (Ce₃Ca₂[(CO₃)₅F₃] | 1.662 | 1.756 |
| Potassium azide (KN₃) | 1.410 | 1.656 |
| [NH₄]₂CO | 1.481 | 1.594 |
| Sodium cyanate (NaOCN) | 1.389 | 1.627 |

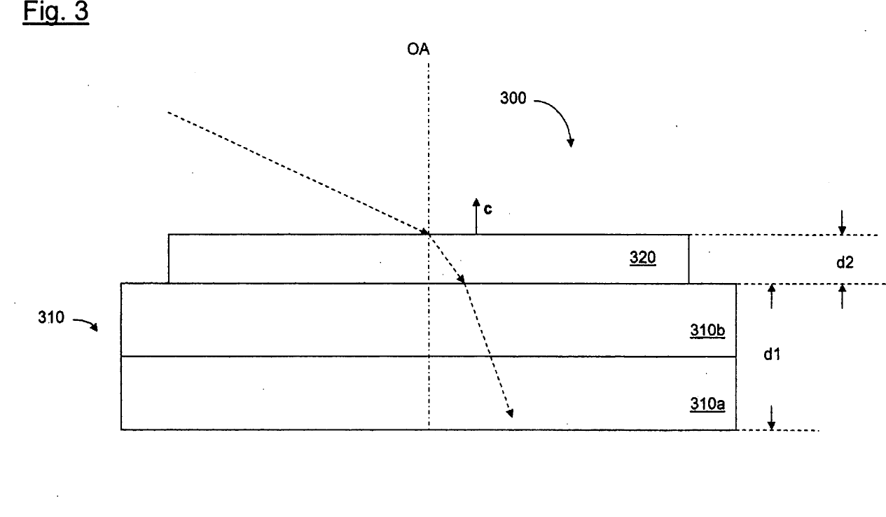

FIG. 3 shows an optical element 300 in accordance with a further embodiment of the invention. The optical element 300 differs from the optical element 100 shown in FIG. 1 only in that the substrate 310 is assembled from two elements 310a and 310b (for example by seamless joining, wringing or the like). In accordance with the illustrated embodiment both elements 310a and 310b are made from calcium fluoride in (111)-orientation and are rotated relative to each other about the axis EA of the element, more specifically ideally through an angle of β=60°+|*120°, wherein | is an integer. As a consequence of the characteristic symmetry of the retardation produced, which is 3-fold in the case of the (111)-orientation, that rotation results in per se known manner in the distribution of the retardation becoming azimuthally symmetrical and involving reduced maximum values in respect of retardation in comparison with a non-rotated arrangement.

The effect of the layer 320 of lanthanum fluoride material which is applied to the substrate 310 is in other respects similar to FIG. 1 but, as a result of the retardation in the substrate 310 which is now rotationally or azimuthally symmetrical it leads to an overall even more effective compensation for the effect of intrinsic birefringence.

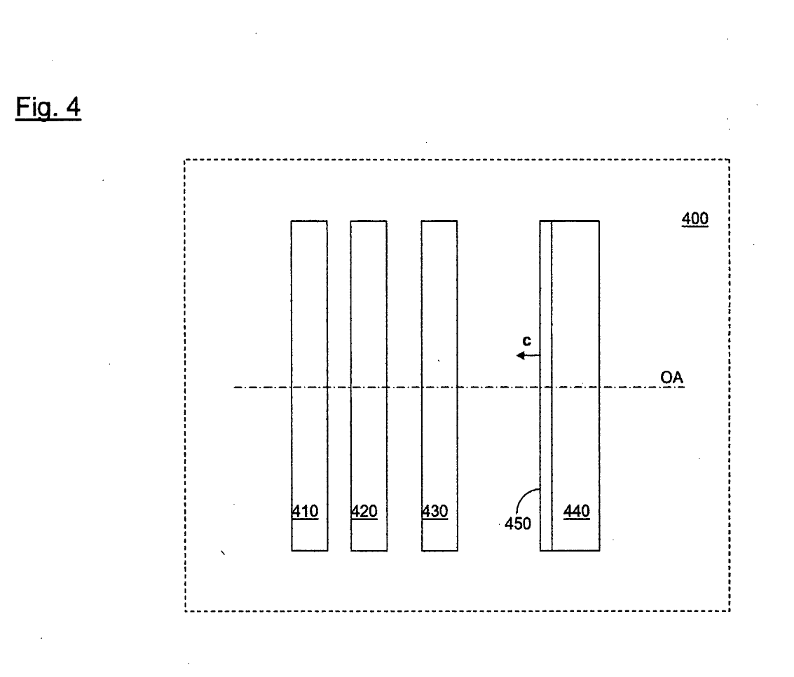

FIG. 4 shows only diagrammatically and to explain the principle involved an optical system 400 in accordance with a preferred embodiment of the invention.

The optical system 400 has a plurality of lenses 410-440 which are arranged along an optical axis OA and which can be made from the same or different material. Just by way of example, for instance the lens 440 as well as the lenses 420 and 430 can be made from calcium fluoride material in (111)-orientation and the lens 410 can comprise for example quartz glass.

In the described embodiment, a layer 450 of lanthanum fluoride material is applied, preferably by epitaxial growth, to the surface 450 in a similar manner to the embodiments shown in FIGS. 1 and 3, in such a way that the optical crystal axis of the layer 450 is parallel to the optical axis OA, that is to say the “c”-direction of the lanthanum fluoride material is oriented along the optical axis.

Unlike the embodiments of FIGS. 1 and 3 in this case the layer 450 is to be of such a thickness d₃ that, for light passing through the optical system 400, the maximum value of the retardation between mutually perpendicular polarization states is reduced in comparison with a corresponding optical system without the layer 450. In other words the thickness d₃ of the layer is so selected that not just the retardation as a consequence of intrinsic birefringence in the calcium fluoride lens 440 but the total retardation, having regard also to the intrinsic birefringence in the further calcium fluoride lenses 420 and 430, is reduced or substantially compensated. It will be appreciated that one or more of the calcium fluoride lenses can also be arranged rotated relative to each other about their lens axis in a suitable fashion or can be composed of elements which are arranged rotated relative to each other about the optical axis in order to achieve a retardation distribution which is as azimuthally symmetrical as possible, similarly to the embodiment in FIG. 3.

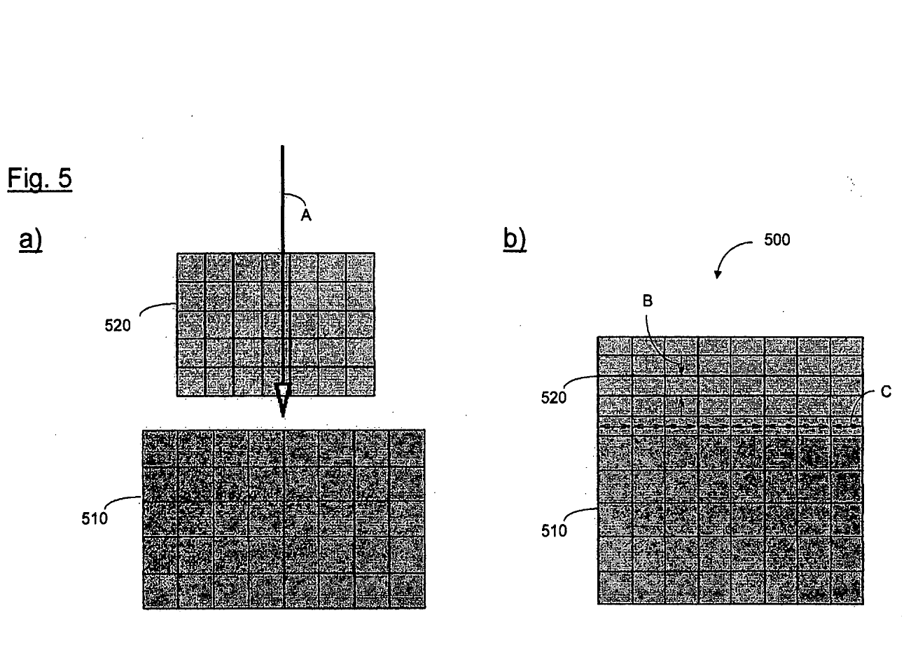

An optical element in accordance with a further embodiment of the present invention will now be described with reference to FIG. 5.

As shown in FIGS. 5a-5b, to produce an optical element 500 on a substrate 510 which is made from a crystal material involving a cubic crystal structure, unlike FIGS. 1 and 3 it is not a non-cubic material but also a material with a cubic crystal structure that is grown thereon, the lattice parameter of which differs slightly from the lattice parameter of the substrate 510 (see FIG. 5a). As is known epitaxial growth also takes place under suitable conditions in such a situation, but in that respect tetragonal distortion of the grown, originally cubic crystal structure 520 occurs (see FIG. 5b, in particular arrows B and C), which relaxes only when relatively large thicknesses are involved (of for example the order of magnitude of 10 μm). That tetragonal distortion introduces birefringence in the grown material 520 which—with an opposite sign in respect of the retardation caused thereby in comparison with the retardation as a consequence of intrinsic birefringence in the substrate—can be used similarly to FIGS. 1 and 3 for compensation for the effect of intrinsic birefringence.

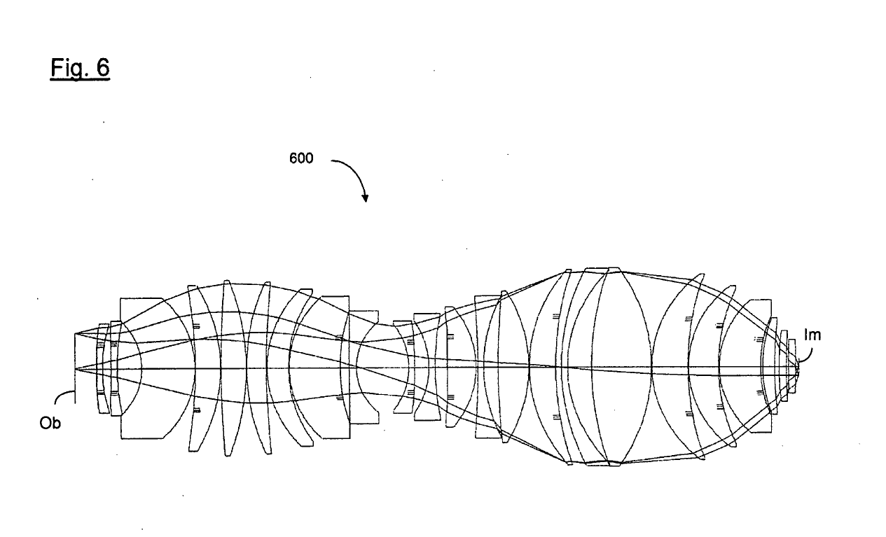

FIG. 6 shows a meridional overall section through a complete projection objective 600 in accordance with an embodiment of the invention. “Ob” and “Im” reference to the object plane or the image plane, respectively.

The design data of the projection objective 600 are set forth in Table 3 is known manner: radii, thicknesses (denote the spacing of the respective surface with respect to the following surface) and half the free diameter of the lenses are specified in millimeters. The surfaces identified by horizontal lines and specified in Table 4 are aspherically curved, the curvature of those surfaces being given by the following aspheric formula:

$$p ( h ) = \frac{( 1 / r ) \cdot {h}^{2}}{1 + \sqrt{1 - ( 1 + K ) {( 1 / r )}^{2} {h}^{2}}} + {C}_{1} {h}^{4} + {C}_{2} {h}^{6} + …$$

Therein P denotes the sagitta of the surface in question in parallel relationship the optical axis, h denotes the radial spacing from the optical axis, r denotes the radius of curvature of the surface in question, K denotes the conical constant and C1, C2, . . . denote the aspheric constants set forth in Table 4. On the last lens element (being a plan-parallel plate of calcium fluoride)), an epitaxially grown layer (such as lanthanum fluoride) can be provided as described above.

TABLE 3
(Design data for FIG. 6)

| | | | | Refractive | |
|---|---|---|---|---|---|
| Surfaces | Radii | Thicknesses | Materials | index | ½ diameter |
| 0 | 0.000000 | 32.000000 | | | 56.1 |
| 1 | 5584.916043 | 7.999815 | SILUV | 1.560383 | 64.6 |
| 2 | 252.733139 | 12.478421 | | | 66.1 |
| 3 | −1106.653902 | 8.999970 | SILUV | 1.560383 | 67.3 |
| 4 | 411.660796 | 35.825515 | | | 70.4 |
| 5 | −107.504587 | 77.413031 | SILUV | 1.560383 | 71.5 |
| 6 | −153.171290 | 0.749946 | | | 107.5 |
| 7 | −755822372 | 36.646313 | SILUV | 1.560383 | 122.3 |
| 8 | −268.661956 | 0.749716 | | | 126.7 |
| 9 | 1841.597943 | 36.395555 | SILUV | 1.560383 | 133.7 |
| 10 | −412.429718 | 0.749749 | | | 134.5 |
| 11 | 340.110618 | 29.183999 | SILUV | 1.560383 | 132.0 |
| 12 | 1313.192649 | 0.750020 | | | 130.4 |
| 13 | 180.155332 | 32.162823 | SILUV | 1.560383 | 121.2 |
| 14 | 212.372347 | 0.750214 | | | 113.3 |
| 15 | 157.808798 | 74.202715 | SILUV | 1.560383 | 109.2 |
| 16 | 269.505830 | 13.360238 | | | 86.2 |
| 17 | 4502.931017 | 10.843533 | SILUV | 1.560383 | 85.0 |
| 18 | 97.814942 | 77.203951 | | | 69.0 |
| 19 | −115.361633 | 8.262929 | SILUV | 1.560383 | 64.7 |
| 20 | −782.986247 | 20.885848 | | | 68.4 |
| 21 | −135.530247 | 9.003111 | SILUV | 1.560383 | 69.2 |
| 22 | 436.198414 | 18.317076 | | | 79.9 |
| 23 | −9372.755083 | 41.677292 | SILUV | 1.560383 | 85.5 |
| 24 | −154.157497 | 2.486682 | | | 91.9 |
| 25 | −1259.359275 | 8.141093 | SILUV | 1.560383 | 100.8 |
| 26 | 256.783050 | 20.889961 | | | 108.8 |
| 27 | 1066.821363 | 45.182482 | SILUV | 1.560383 | 111.6 |
| 28 | −237.103167 | 0.749846 | | | 115.8 |
| 29 | 241.846545 | 38.633854 | SILUV | 1.560383 | 150.0 |
| 30 | 554.712372 | 17.544169 | | | 149.6 |
| 31 | 0.000000 | −9.413386 | | | 149.0 |
| 32 | 356.425316 | 9.067150 | SILUV | 1.560383 | 152.1 |
| 33 | 220.827914 | 35.407289 | | | 149.1 |
| 34 | 491.398548 | 88.531534 | SILUV | 1.560383 | 149.5 |
| 35 | −282.481121 | 0.749846 | | | 153.1 |
| 36 | 188.165394 | 53.268448 | SILUV | 1.560383 | 144.0 |
| 37 | 489.183725 | 0.749839 | | | 140.2 |
| 38 | 164.315082 | 44.210578 | SILUV | 1.560383 | 124.7 |
| 39 | 324.740406 | 0.761915 | | | 118.1 |
| 40 | 143.254185 | 60.777536 | SILUV | 1.560383 | 101.9 |
| 41 | 233.762323 | 3.105795 | | | 74.2 |
| 42 | 229.098246 | 17.317978 | SILUV | 1.560383 | 72.4 |
| 43 | 616.535908 | 6.489606 | | | 65.0 |
| 44 | 401.865700 | 11.060457 | SILUV | 1.560383 | 51.5 |
| 45 | 769.552246 | 3.250206 | | | 44.0 |
| 46 | 0.000000 | 10.000000 | CAFUV | 1.501041 | 37.8 |
| 47 | 0.000000 | 5.000000 | | | 29.6 |
| 48 | 0.000000 | 0.000000 | | | 14.0 |

TABLE 4
(Aspheric constants for FIG. 6)

| Surface | 1 | 3 | 7 | 16 | 20 |
|---|---|---|---|---|---|
| K | 0 | 0 | 0 | 0 | 0 |
| C1 | 2.159182E−07 | 3.277882E−08 | −1.911920E−09 | −3.900582E−08 | −7.640008E−09 |
| C2 | −2.473594E−11 | 1.275573E−11 | 2.239297E−13 | 1.131619E−12 | −2.973190E−12 |
| C3 | 1.766655E−15 | −1.052574E−15 | 5.437281E−18 | 2.328430E−17 | −5.151633E−16 |
| C4 | −1.561760E−19 | 3.989308E−20 | 2.292330E−23 | −3.684461E−21 | 2.205835E−20 |
| C5 | 2.325958E−24 | 8.331878E−24 | −3.761935E−27 | 2.089060E−26 | 2.481969E−24 |
| C6 | 2.059509E−29 | −4.782756E−28 | −1.133771E−32 | 1.445201E−29 | −2.268235E−28 |
| Surface | 23 | 30 | 37 | 39 | 41 |
| K | 0 | 0 | 0 | 0 | 0 |
| C1 | −6.353190E−08 | 4.380777E−09 | 1.894472E−09 | 2.575735E−10 | 1.607491E−08 |
| C2 | 3.056814E−12 | −4.859959E−14 | 2.338362E−13 | 3.555788E−13 | 5.646212E−12 |
| C3 | −1.446418E−16 | 2.345513E−18 | −6.040107E−18 | 1.199259E−17 | −1.529454E−16 |
| C4 | 8.630394E−21 | −3.787779E−23 | 1.747137E−22 | −1.117883E−21 | 6.412191E−21 |
| C5 | −2.745582E−25 | 4.321225E−28 | 1.405792E−27 | 9.209761E−27 | 7.103269E−25 |
| C6 | 9.701773E−30 | −6.042727E−33 | 1.977182E−32 | 2.299428E−31 | −7.402557E−29 |

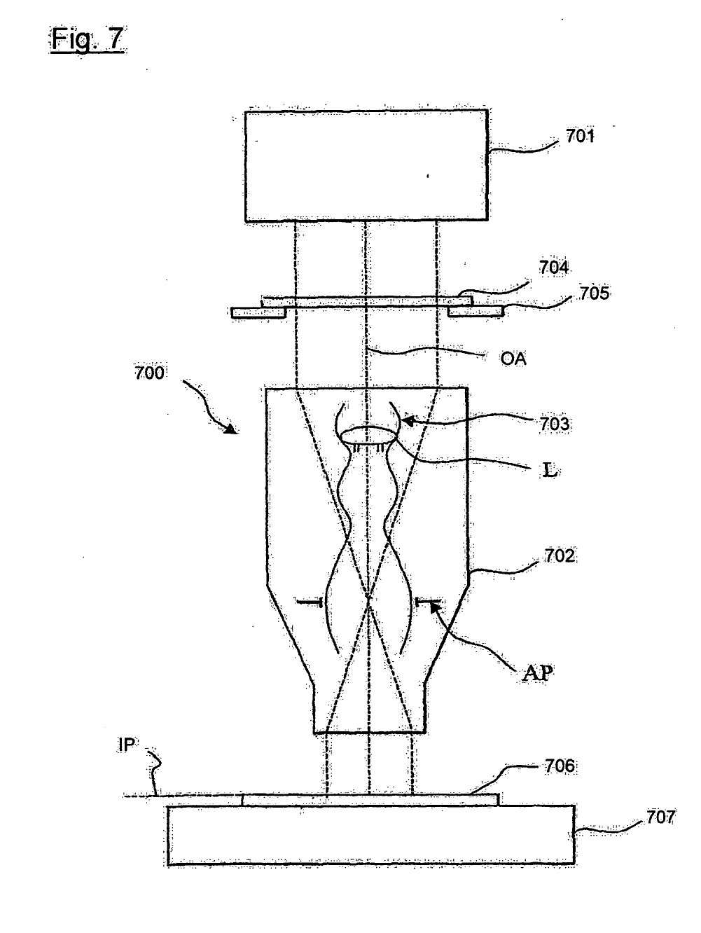

FIG. 7 shows a diagrammatic view of the structure in principle of a microlithographic projection exposure apparatus with an illumination system and a projection objective, in which one or more optical elements and/or optical systems according to the invention can be particularly used.

Referring to FIG. 7 a microlithographic projection exposure apparatus 700 has an illumination system 701 and a projection objective 702. The projection objective 702 includes a lens arrangement 703 with an aperture plate AP, an optical axis OA being defined by the only diagrammatically indicated lens arrangement 703. An embodiment by way of example of the lens arrangement 703 is shown in FIG. 6. Arranged between the illumination system 701 and the projection objective 702 is a mask 704 which is held in the beam path by means of a mask holder 705. Such masks 704 which are used in microlithography have a structure in the micrometer to nanometer range, which is imaged by means of the projection objective 702 reduced for example by a factor of 4 or 5 on an image plane IP. A light-sensitive substrate 706 or a wafer which is positioned by a substrate holder 707 is positioned in the image plane IP. The minimum structures which can still be resolved depend on the wavelength λ of the light used for illumination purposes and on the image-side numerical aperture of the projection objective 702, wherein the maximum achievable resolution of the projection exposure apparatus 700 rises with decreasing wavelength λ of the illumination system 701 and with an increasing image-side numerical aperture of the projection objective 702.

If the invention has been described by reference to specific embodiments numerous variations and alternative embodiments present themselves to the man skilled in the art, for example by combination and/or exchange of features of individual embodiments. Accordingly it will be appreciated by the man skilled in the art that such variations and alternative embodiments are also embraced by the present invention and the scope of the invention is limited only in the sense of the accompanying claims and equivalents thereof.

1. An optical element, comprising:
a substrate which, for light of a wavelength which λ that passes through the substrate, causes a first retardation between mutually perpendicular polarization states of the light of the wavelength λ; and
a layer which is epitaxially grown on the substrate, the layer comprising material with a non-cubic crystal structure,
wherein:
for light of the wavelength λ that passes through the layer, a natural birefringence of the material with the non-cubic structure causes a second retardation between the mutually perpendicular polarization states of the light of the wavelength λ,
the second retardation at least partially compensates for the first retardation caused, and
the optical element is configured to be used in an illumination system of a microlithographic projection exposure apparatus.

2. An optical element as set forth in claim 1 wherein a maximum value of a total retardation between the mutually perpendicular polarization states of the light of the wavelength λ passing through the optical element is reduced by at least 25% in comparison with a maximum value of a total retardation between the mutually perpendicular polarization states of light of the wavelength λ passing through an optical element with an otherwise identical substrate without the layer.

3. An optical element as set forth in claim 1 wherein the layer comprises an optically uniaxial crystal material.

4. An optical element as set forth in claim 3 wherein an optical crystal axis of the optically uniaxial crystal material is substantially parallel to an axis (EA) of the optical element.

5. An optical element as set forth in claim 1 wherein only said the one epitaxially grown layer is provided on the substrate.

6. An optical element as set forth in claim 1 wherein the substrate comprises a material with a cubic crystal structure, and the first retardation is caused by virtue of intrinsic birefringence.

7. An optical element as set forth in claim 1 wherein the substrate has a crystal cut so that the axis of the element is substantially parallel to the <111>-crystal direction.

8. An optical element as set forth in claim 7 wherein the material of the layer is of a hexagonal or trigonal crystal structure.

9. An optical element as set forth in claim 1 wherein the substrate has a crystal cut so that the axis of the element is substantially parallel to the <100>-crystal direction.

10. An optical element as set forth in claim 9 wherein the material of the layer is of a tetragonal crystal structure.

11. An optical element as set forth in claim 1 wherein the substrate has a crystal cut so that the axis of the element is substantially parallel to the <110>-crystal direction.

12. An optical element as set forth in claim 11 wherein the material of the layer is of a monoclinic crystal structure.

13. An optical element as set forth in claim 1 wherein the substrate comprises a material selected from the group consisting of calcium fluoride (CaF₂), strontium fluoride (SrF₂), barium fluoride (BaF₂), lithium fluoride (LiF), sodium fluoride (NaF), potassium fluoride (KF), rubidium fluoride (RbF), cesium fluoride (CsF) and combinations thereof.

14. An optical element as set forth in claim 1 wherein the material of the layer is selected from the group consisting of lanthanum fluoride (LaF₃), magnesite (MgCO₃), dolomite (CaMg[CO₃]₂), rhodochrosite (MnCO₃), gehlenite (2CaO.Al₂O₃SiO₂), calcite (CaCO₃), smithsonite (ZnCO₃), sodium nitrate (NaNO₃), potassium cyanate (KCNO), eitelite (MgNa₂[CO₃]₂ or Na₂CO₃.MgCO₃), potassium magnesium carbonate (MgK₂[CO₃]₂ or K₂CO₃.MgCO₃), chloromagnesite (MgCl₂), RbClO₃, buttschlitt (Ca₂K₆[CO₃]₅.6H₂O), SrCl₂.6H₂O, lithium nitrate (LiNO₃), LiO₃, norsethite (BaMg[CO₃]₂ or BaCO₃.MgCO₃), cordylite (Ce₂Ba[(CO₃)₃F₂] or La₂Ba[(CO₃)₃F₂], Ba(NO₂)₂.H₂O, Al₂O₃.MgO, manganese dolomite (MnCa[CO₃]₂ or MnCO₃.CaCO₃), manganese spar (MnCO₃), siderite (FeCO₃), [PdCl₄](NH₄)₂, barium borate (BaB₂O₄) and combinations thereof.

15. An optical element as set forth in claim 1 wherein the substrate comprises a material with a spinel structure.

16. An optical element as set forth in claim 1 wherein the substrate comprises a material selected from the group consisting of yttrium aluminum garnet (Y₃Al₅O₁₂), magnesian spinel (MgAl₂O₄), calcium spinel (CaAl₂O₄), manganese spinel (MnAl₂O₄), lithium spinel (Al₅O₈Li), pyrope (Mg₃Al₂Si₃O₁₂) and combinations thereof.

17. An optical element as set forth in claim 15 wherein the material of the layer is selected from the group consisting of NaCNO, henotim (Y[PO₄]), bastnaesite ((Ce,La,Nd)[CO₃F]), synchysite (CeCa[(CO₃)₂F], parisite ((Ce,La)₂Ca[(CO₃)₃F₂]³), röntgenite (Ce₃Ca₂[(CO₃)₅F₃], potassium azide (KN₃), [NH₄]₂CO, sodium cyanate (NaOCN) and combinations thereof.

18. An optical element as set forth in claim 1 wherein the substrate is composed of two elements of the same crystal cut which are arranged rotated relative to each other about the axis (EA) of the element.

19. An optical element as set forth in one claim 1 wherein the substrate comprises a material with a non-cubic crystal structure, wherein the first retardation is caused by virtue of natural birefringence.

20. An optical element, comprising:
a substrate comprising calcium fluoride crystal in (111)-orientation, the first substrate having a first thickness (d1); and
a layer which is epitaxially grown on the substrate, the layer comprising lanthanum fluoride, and the layer having a second thickness (d2);
wherein the ratio (d1/d2) of the first thickness to the second thickness is at least 7×10³,
wherein the optical element is configured to be used in an illumination system of a microlithographic projection exposure apparatus.

21. An optical element as set forth in claim 20 wherein the ratio (d1/d2) of the first thickness to the second thickness is at least 8×10³.

22. An optical element as set forth in claim 1 wherein the wavelength λ is less than 250 nm.

23. An optical system comprising:
a plurality of lenses; and
a layer of a material with a non-cubic crystal structure,
wherein:
the layer of the material with the non-cubic structure is epitaxially grown one of the plurality of lenses;
for light of the wavelength λ that passes through the layer, the layer causes a retardation between mutually perpendicular polarization states of the light of the wavelength;
an optical crystal axis of the material with the non-cubic structure is substantially parallel to an optical axis of the optical system; and
for light of the wavelength λ that passes through the optical system, a maximum value of retardation between the mutually perpendicular polarization states of the light of the wavelength λ is reduced in comparison to an otherwise identical system without the layer.

24. The optical system s set forth in claim 23 wherein the maximum value of retardation between the mutually perpendicular polarization states of the light of the wavelength λ passing through the optical element is reduced by at least 25% in comparison with a maximum value of a total retardation between the mutually perpendicular polarization states of light of the wavelength λ passing through an optical element with an otherwise identical optical system without the layer.

25. An optical system as set forth in claim 23 wherein at least two lenses of the plurality of lenses are of the same crystal cut and are arranged rotated relative to each other about their optical axis.

26. A microlithographic projection exposure apparatus comprising:
an illumination system; and
a projection objective,
wherein the microlithographic projection exposure apparatus system comprises the optical element of claim 1.

27. A microlithographic projection exposure apparatus as set forth in claim 26 wherein the projection objective has an image-side numerical aperture (NA) of at least 0.8.
